(19) United States
(12) Patent Application Publication
(10) Pub. No.: US 2017/0043830 A1
(43) Pub. Date: Feb. 16, 2017

(54) BICYCLE THEFT-PROOF METHOD AND APPARATUS

(71) Applicants: LE HOLDINGS (BEIJING) CO., LTD., Beijing (CN); LETV SPORTS CULTURE DEVELOP (BEIJING) CO., LTD., Beijing (CN)

(72) Inventor: Dalong LI, Beijing (CN)

(21) Appl. No.: 15/233,388

(22) Filed: Aug. 10, 2016

Related U.S. Application Data
(63) Continuation of application No. PCT/CN2016/081965, filed on May 13, 2016.

(30) Foreign Application Priority Data
Aug. 11, 2015 (CN) 201510491063.6

(51) Int. Cl. B62H 5/20

(52) U.S. Cl. CPC B62H 5/20

(57) ABSTRACT

The disclosure provides a bicycle theft-proof method and apparatus, where the method includes: obtaining current position information of a bicycle which is locked; comparing the current position information with pre-stored initial position information of the bicycle; and performing an alarming operation if the current position information is different from the initial position information of the bicycle. With the technical solutions according to the embodiments of the disclosure, if it is determined that the current position information of the bicycle is different from the initial position information of the bicycle, then the alarming operation will be performed so that a user can obtain the state of the bicycle in a timely manner, thus improving in effect the theft-proof function of the bicycle; and it can be determined only by comparing the two pieces of position information whether to perform the alarming operation to thereby safeguard the bicycle conveniently and rapidly.

### CROSS REFERENCE TO RELATED APPLICATIONS

This application is a continuation of International Application No. PCT/CN2016/081965, filed on May 13, 2016, which is based upon and claims priority to Chinese Patent Application No. 201510491063.6, filed on Aug. 11, 2015, which is hereby incorporated by reference in its entirety.

### TECHNICAL FIELD

The present disclosure relates to the field of manufacturing a bicycle, and particularly to a bicycle theft-proof method and apparatus.

### BACKGROUND

Bicycles have become popular to people due to their economy and cheapness, convenience and rapidness, and environment-conserving while traveling, but the bicycles are so light-weighted that they tend to be stolen, so they may not be safeguarded even if locks are added thereto, and as a result, their safety may still fail to be guaranteed; and also there are some bicycles provided with alarms, but the alarms still operate under the fundamental vibration principle without involving any combination of automatic control and mechanical principles, so the bicycles may still suffer from the risk of being stolen.

As can be apparent, there is a poor theft-proof function of the bicycles in the prior art.

### SUMMARY

The present disclosure provides a method and apparatus for safeguarding a bicycle against a theft so as to address the poor theft-proof function of the bicycles in the prior art.

Particular technical solutions according to the embodiments of the disclosure are as follows:

An embodiment of the disclosure provides a bicycle theft-proof method including:

obtaining current position information of a bicycle which is locked;

comparing the current position information with pre-stored initial position information of the bicycle, which is information about the position where the bicycle is located while being locked; and

performing an alarming operation if the current position information is different from the initial position information of the bicycle.

An embodiment of the disclosure provides a bicycle theft-proof apparatus including:

a position information obtaining unit configured to obtain current position information of a bicycle which is locked;

a processing unit configured to compare the current position information with pre-stored initial position information of the bicycle, which is information about the position where the bicycle is located while being locked; and

a alarming unit configured to perform an alarming operation if the current position information is different from the initial position information of the bicycle.

In the embodiments of the disclosure, the current position information of the bicycle is obtained; the current position information is compared with the pre-stored initial position information of the bicycle; and if the current position information is different from the initial position information of the bicycle, then the alarming operation will be performed. With the technical solutions according to the embodiments of the disclosure, if it is determined that the current position information of the bicycle is different from the initial position information of the bicycle, then it will be determined that the bicycle is stolen, and the alarming operation will be performed, so that a user can obtain the state of the bicycle in a timely manner, thus improving in effect the theft-proof function of the bicycle; and it can be determined only by comparing the two pieces of position information whether to perform the alarming operation to thereby safeguard the bicycle conveniently and rapidly.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of a bicycle theft-proof system according to some embodiments;

FIG. 2 is a flow chart of a bicycle theft-proof flow according to some embodiments;

FIG. 3 is a schematic structural diagram of a bicycle theft-proof apparatus according to some embodiments;

FIG. 4 is another schematic structural diagram of the bicycle theft-proof apparatus according to some embodiments; and

FIG. 5 is a schematic structural diagram of a bicycle according to some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

Referring to FIG. 1 illustrating a schematic structural diagram of a bicycle theft-proof system according to an embodiment of the disclosure, the bicycle theft-proof system includes a bicycle and a terminal. Particularly the bicycle has a position information obtaining unit, a storage unit, a processing unit, an alarming unit, and a communication unit installed therein, where the position information obtaining unit is configured to obtain initial position information and current position information of the bicycle; the storage unit is configured to store the initial position information of the bicycle; the processing unit is configured to compare the current position information of the bicycle with the initial position information in the storage unit, and to instruct the alarming unit to perform an alarming operation, in response to a comparison result; the alarming unit is configured to perform the alarming operation; and the communication unit is configured to transmit an alarm signal to the outside. The terminal is a device paired with the bicycle, and configured to receive the alarm signal transmitted by the communication unit, and to alarm a user in response to the alarm signal. In a particular implementation, the terminal can be an intelligent key, a mobile phone, a tablet computer, or another device.

The embodiments of the disclosure will be described below in further details with reference to the drawings.

### First Embodiment

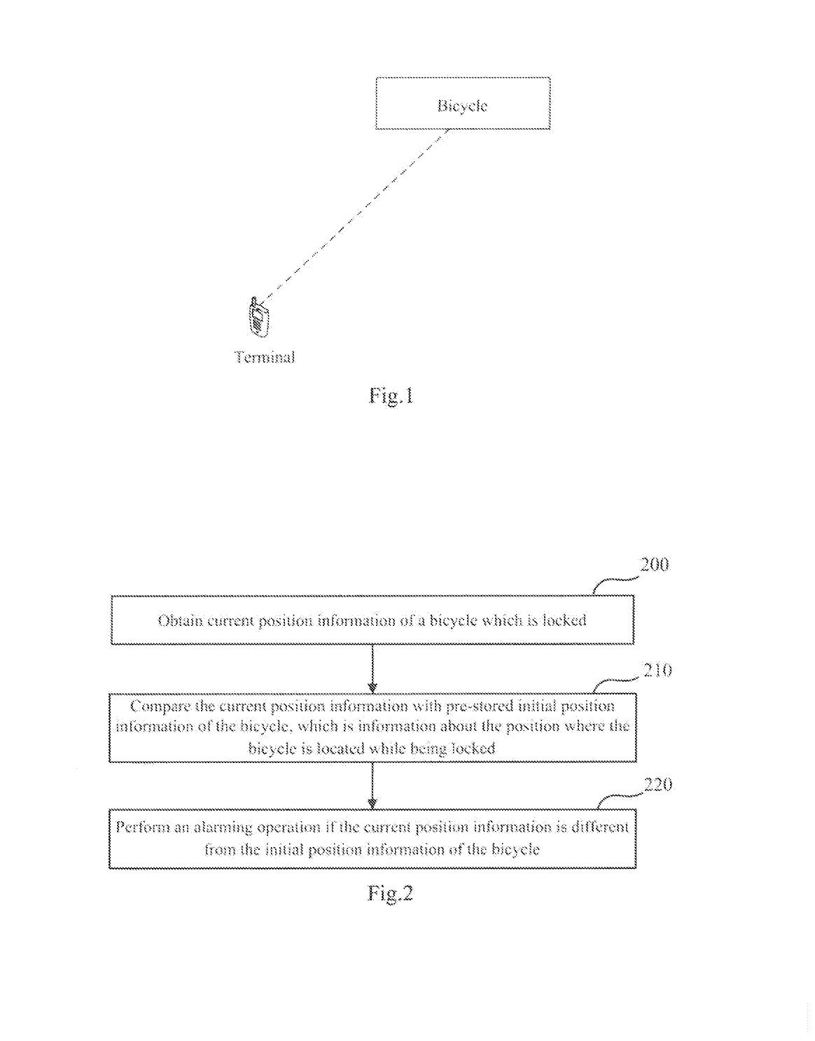

Referring to FIG. 2, a bicycle theft-proof process according to this embodiment of the disclosure includes:

The operation 200 is to obtain current position information of a bicycle which is locked.

In an embodiment of the disclosure, if the bicycle becomes locked, then the current position information of the bicycle will be obtained as initial position information of the bicycle, and stored in a storage unit of the bicycle.

Optionally the current position information of the bicycle can be obtained in real time; or the current position information of the bicycle can be obtained at a preset periodicity to thereby save power consumption of the system; or an instruction to obtain position information can be transmitted by a terminal paired with the bicycle to the bicycle, and the bicycle can transmit the current position information thereof to the terminal in response to the instruction to obtain position information so that the current position information of the bicycle can be obtained flexibly.

Furthermore the bicycle further includes a gyroscope, where before the current position information of the bicycle is obtained, a change of angle of the bicycle can be further detected by the gyroscope, and only if the change of angle of the bicycle is detected by the gyroscope, then the current position information of the bicycle will be obtained instead of obtaining in real time the position information of the bicycle, to thereby save power consumption of the bicycle, and signaling interaction between the bicycle and the terminal so as to save resources of the system, and to improve the performance of the system in effect.

Optionally the position information, of the bicycle can be obtained, that is, the position information can be obtained by a position information obtaining unit in the bicycle, or by the gyroscope and an acceleration meter in the bicycle, particularly as follows:

In a first approach, the current position information of the bicycle ears be obtained by a position information obtaining unit in the bicycle, which can include a satellite positioning system (e.g., the GPS, the GLONASS, the Beidou Navigation System, etc.), and corresponding peripheral devices thereof.

In a second approach, the bicycle can be positioned by the gyroscope and an acceleration meter, where the gyroscope can be integrated in the position information obtaining unit to thereby reduce the volume of the position information obtaining unit so as to improve the integration of the bicycle. Preferably the gyroscope is located at the gravity center of the bicycle to thereby a detection result of the gyroscope while the bicycle is traveling from being affected by an eccentric force so as to improve the accuracy of the detection result.

If the bicycle is moving, then the bicycle can calculate the direction in which and the distance over which the bicycle moves, using the gyroscope and the acceleration meter according to the initial position information of the bicycle to thereby determine the current position information of the bicycle, particularly as follows:

The gyroscope determines the angular speed of the moving bicycle, temporally integrates the angular speed, and determines the angle at which the moving bicycle is inclined; and the acceleration meter calculates the acceleration of the bicycle according to the inclination angle, determines the direction in which and the distance over which the bicycle moves, according to the acceleration of the bicycle, and obtains the current position information of the bicycle according to the initial position information of the bicycle, and the direction in which and the distance over which the bicycle moves.

Where the direction in which the bicycle moves can be determined by the direction of the acceleration, which can be determined by the direction of the angular speed; and the distance over which the bicycle moves can be determined in the equation of:

s=v₀t+at²,

Where s represents the distance over which the bicycle moves; v₀ represents an initial speed, which is zero because the bicycle is locked; a represents an acceleration obtained by the acceleration meter; and t represents the length of time for which the bicycle has moved.

Optionally the gyroscope is a three-axis gyroscope, and the acceleration meter is a three-axis acceleration meter. With this technical solution, the gyroscope can detect angular variations of the bicycle in respective directions, and the acceleration meter can detect variations of impact forces of the bicycle in the respective directions.

Optionally the gyroscope is a laser gyroscope, and since the laser gyroscope is highly accurate, the laser gyroscope can assist in positioning the bicycle to thereby improve the accuracy of a positioning result; or the gyroscope can be a micro electrical-mechanical gyroscope, and since the micro electrical-mechanical gyroscope has the advantages of being highly integrated, and a small volume, the micro electrical-mechanical gyroscope can assist in positioning the bicycle to thereby improve the integration of the bicycle.

With the technical solution, the bicycle can be positioned by the gyroscope and the acceleration meter even in an environment, beyond the reach by the GPS (e.g., a tunnel, etc.), to thereby avoid the current position information of the bicycle from failing to be obtained due to the environmental factor so as to improve the reliability of obtaining the position information of the bicycle.

Furthermore the bicycle further includes a temperature sensor configured to compensate for an error in the detection results of the gyroscope and the acceleration meter due to an influence from temperature.

Furthermore the bicycle further includes a filter configured to correct for the inclination angle as a result of integration to thereby improve the accuracy of the inclination angle.

Optionally the gyroscope and the acceleration meter can further assist the GPS in positioning the bicycle to thereby improve the accuracy of the positioning result.

The operation 210 is to compare the current position information with pre-stored initial position information of the bicycle, which is information about the position where the bicycle is located while being locked.

In an embodiment of the disclosure, a processing unit in the bicycle compares the current position information with the pre-stored initial position information to determine whether the bicycle is moving.

The operation 220 is to perform an alarming operation if the current position information is different from the initial position information of the bicycle.

In an embodiment of the disclosure, if the current position information is the same as the initial position information of the bicycle, then the bicycle will not perform the alarming operation; and if the current position information is different from the initial position information of the bicycle, then the bicycle will perform the alarming operation.

Optionally the bicycle can perform the alarming operation by triggering an alarming unit in the bicycle so that an alarm whistle in the alarming unit produces an audible alarm, or by triggering a part or all of lamps on the bicycle to be switched on, and triggering the alarming unit to generate and transmit an alarm signal to the terminal paired with the bicycle.

Optionally the bicycle triggers the alarming unit to generate and transmit the alarm signal to the terminal paired with the bicycle particularly as follows:

The alarm signal is transmitted to the terminal paired with the bicycle through a Bluetooth module; or the alarm signal is transmitted to the terminal paired with the bicycle through an infrared module; or the alarm signal is transmitted to the terminal paired with the bicycle over a wireless network, where the alarm signal is configured to notify the terminal paired with the bicycle that the bicycle is stolen; and optionally the alarm signal can be embodied in the form of a short message or a call by phone. Furthermore if the terminal paired with the bicycle is an intelligent key, then the alarm signal can be further configured to control the intelligent key to vibrate or to make a sound.

Here if a communication unit of the bicycle transmits the alarm signal to the terminal paired with the bicycle over the wireless network, then the communication unit can include 3rd-Generation (3G)/4th Generation (4G) mobile communication Subscriber Identity Module (SIM) card, a Radio Frequency Identification (RF) circuit, and peripheral circuits.

Optionally the bicycle starts a backup lock to lock the bicycle while performing the alarming operation, where the backup lock can be located in the bicycle so as not to occupy any external space on the bicycle, so that the bicycle will have a pleasing appearance and occupy a smaller space while improving the safety of the bicycle.

Furthermore after the alarm signal is transmitted to the terminal paired with the bicycle, the current position information is transmitted to the terminal paired with the bicycle so that the user can determine the current position of the bicycle to thereby get back the bicycle rapidly.

If the obtained current position information is different from the pre-stored initial position information of the bicycle, then the method in an embodiment of the disclosure will further include:

An image acquiring unit of the bicycle is invoked to obtain and transmit an image of the current surrounding environment of the bicycle to the terminal, where the image acquiring unit can be embodied as a webcam; or an audio signal receiving unit of the bicycle is invoked to obtain and transmit sound of the current surrounding environment of the bicycle to the terminal, where the audio signal receiving unit can be embodied as a microphone, so that a human operator can obtain the image or sound of the current surrounding environment of the bicycle using the terminal to thereby further facilitate getting back the bicycle.

Optionally the lock of the bicycle is fixed in the bicycle, and can be an electromagnetic lock which is electromagnetically connected with and can be removed from the bicycle and installed on another vehicle (e.g., another bicycle, an automobile, etc.) to thereby improve the flexibility of the lock in use.

Optionally the bicycle further includes a power supply unit configured to power the respective functional units in the bicycle, the lamps of the bicycle, the lock, and other components thereof.

With the technical solution according to the embodiment of the disclosure, if it is determined that the current position information of the bicycle is different from the initial position information of the bicycle, then the alarming operation will be performed so that the user can obtain the state of the bicycle in a timely manner, thus improving in effect the theft-proof function of the bicycle; and it can be determined by comparing the two pieces of position information whether to perform the alarming operation to thereby safeguard the bicycle conveniently and rapidly.

### Second Embodiment

Further to the technical solution above, referring to FIG. 3, an embodiment of the disclosure further provides a bicycle theft-proof apparatus including a position information obtaining unit 30, a processing unit 31, and an alarming unit 32, where:

The position information obtaining unit 30 is configured to obtain current position information of a bicycle which is locked;

The processing unit 31 is configured to compare the current position information with pre-stored initial position information of the bicycle, which is information about the position where the bicycle is located while being locked; and

The alarming unit 32 is configured to perform an alarming operation if the current position information is different from the initial position information of the bicycle.

Optionally the position information obtaining unit 30 is configured: to obtain the current position information of the bicycle, or to obtain the current position information of the bicycle according to initial position information of the bicycle.

Optionally the position information obtaining unit 30 configured to obtain the current position information of the bicycle according to the initial position information of the bicycle is configured: to determine the angular speed of the moving bicycle, to temporally integrate the angular speed, and to determine the angle at which the moving bicycle is inclined; and to calculate the acceleration of the bicycle according to the inclination angle, to instruct the processing unit 31 in the apparatus to determine the direction in which and the distance over which the bicycle moves, according to the acceleration of the bicycle, and to obtain the current position information of the bicycle according to the initial position information of the bicycle, and the direction in which and the distance over which the bicycle moves.

Optionally the alarming unit 32 is configured: to trigger an alarm whistle to produce an alarm; or to trigger a part or all of lamps on the bicycle to be switched on.

Furthermore the position information obtaining unit 30 is further configured to detect a change of angle of the bicycle before the current position information of the bicycle is obtained.

Optionally the position information obtaining unit 30 is configured: to obtain the current position information of the bicycle, or to obtain the current position information of the bicycle according to initial position information of the bicycle.

Optionally the position information obtaining unit 30 is configured to obtain the current position information of the bicycle according to the initial position information of the bicycle is configured: to determine the angular speed of the moving bicycle, to temporally integrate the angular speed, and to determine the angle at which the moving bicycle is inclined; and to calculate the acceleration of the bicycle according to the inclination angle, to instruct the processing unit 31 in the apparatus to determine the direction in which and the distance over which the bicycle moves, according to the acceleration of the bicycle, and to obtain the current position information of the bicycle according to the initial position information of the bicycle, and the direction in which and the distance over which the bicycle moves.

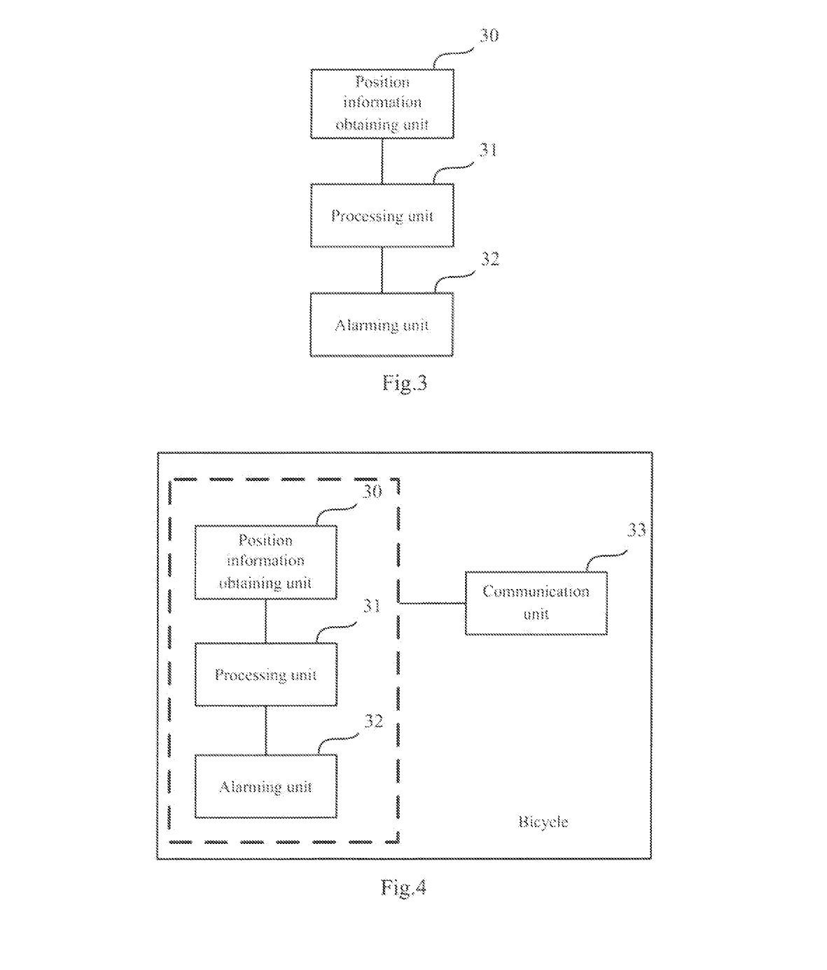

Optionally the alarming unit 32 is configured: to trigger an alarm whistle to produce an alarm; or to trigger a part or all of lamps on the bicycle to be switched on; or referring to FIG. 4, furthermore the apparatus further includes a communication unit 33 configured to transmit an alarm signal to a terminal paired with the bicycle in response to the alarm of the alarming unit 32.

Optionally the communication unit 33 is configured to transmit the alarm signal to the terminal paired with the bicycle through a Bluetooth module; or to transmit the alarm signal to the terminal paired with the bicycle through an infrared module; or to transmit the alarm signal to the terminal paired with the bicycle over a wireless network.

Furthermore the communication unit 33 is further configured to transmit the current position information to a terminal paired with the bicycle after an alarm signal is to the terminal paired with the bicycle.

Optionally the communication unit 33 is configured: to transmit the alarm signal to the terminal paired with the bicycle through a Bluetooth module; or to transmit the alarm signal to the terminal paired with the bicycle through an infrared module; or to transmit the alarm signal to the terminal paired with the bicycle over a wireless network, where the alarm signal is configured to notify the terminal paired with the bicycle that the bicycle is stolen; and optionally the alarm signal can be embodied in the form of a short message or a call by phone. Furthermore if the terminal paired with the bicycle is an intelligent key, then the alarm signal can be further configured to control the intelligent key to vibrate or to make a sound.

Optionally the communication unit 33 is further configured to transmit the current position information to a terminal paired with the bicycle after an alarm signal is to the terminal paired with the bicycle.

Optionally the processing unit 31 is further configured: to obtain a length of time for which the bicycle has been stationary; and if the length of time reaches a preset length of time threshold, to enable a lock on the bicycle to lock the bicycle, where the preset length of time can be preset freely, for example, the value of the preset length of time can be 30 minutes.

Optionally the communication unit 33 is configured to receive position information of a terminal paired with the bicycle; and the processing unit 31 is configured to calculate the distance between the terminal and the bicycle according to position information of the terminal, and the current position information of the bicycle, and if the calculated distance reaches a preset distance threshold, to enable a lock on the bicycle to lock the bicycle, where the preset distance threshold can be preset freely, fore example, the preset distance threshold can be 100 meters.

### Third Embodiment

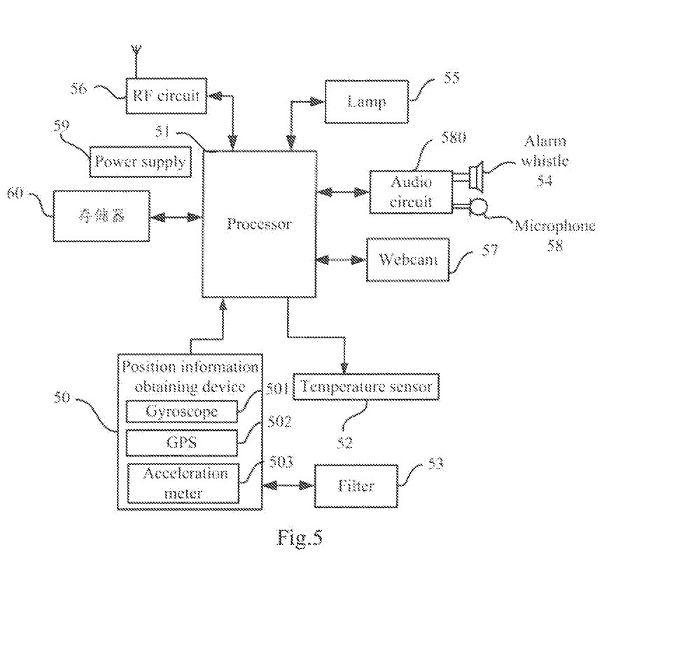

Further to the technical solution above, referring to FIG. 5, an embodiment of the disclosure further provides a bicycle including a position information obtaining device 50 and a processor 51, a memory communicably connected with the at least one processor for storing instructions executable by the at least one processor, wherein execution of the instructions by the at least one processor:

The position information obtaining device 50 is configured to obtain current position information of the bicycle which is locked;

The processor 51 is configured to compare the current position information with pre-stored initial position information of the bicycle, which is information about the position where the bicycle is located while being locked; and

The processor 51 is further configured to perform an alarming operation if the current position information is different from the initial position information of the bicycle.

Furthermore the position information obtaining device 50 includes a gyroscope 501 configured to detect a change of angle of the bicycle before the current position information of the bicycle is obtained.

The gyroscope 501 is a laser gyroscope, and since the laser gyroscope is highly accurate, the laser gyroscope can assist in positioning the bicycle to thereby improve the accuracy of a positioning result; or the gyroscope can be a micro electrical-mechanical gyroscope, and since the micro electrical-mechanical gyroscope has the advantages of being highly integrated, and a small volume, the micro electrical-mechanical gyroscope can assist in positioning the bicycle to thereby improve the integration of the bicycle.

Optionally the gyroscope 501 is a three-axis gyroscope, and with this technical solution, the gyroscope can detect angular variations of the bicycle in respective directions.

Where the gyroscope 501 can be integrated in the position information obtaining device 50 to thereby reduce the volume of the position information obtaining unit so as to improve the integration of the bicycle. Preferably the gyroscope 501 is located at the gravity center of the bicycle to thereby a detection result of the gyroscope 501 while the bicycle is traveling from being affected by an eccentric force so as to improve the accuracy of the detection result.

Optionally the position information obtaining device 50 includes a GPS 502 configured to obtain the current position information of the bicycle; and

Optionally the position information obtaining device 50 can further include an acceleration meter 503, where the gyroscope 501 and the acceleration meter 503 are configured to obtain the current position information of the bicycle according to initial position information of the bicycle.

Optionally if the position information obtaining device 50 can further include the acceleration meter 503 and the gyroscope 501, then the gyroscope 501 will be configured to determine the angular speed of the moving bicycle, to temporally integrate the angular speed, and to determine the angle at which the moving bicycle is inclined; and

The acceleration meter 503 is configured to calculate the acceleration of the bicycle according to the inclination angle;

Where the processor 51 is further configured to determine the direction in which and the distance over which the bicycle moves, according to the acceleration of the bicycle, and to obtain the current position information of the bicycle according to the initial position information of the bicycle, and the direction in which and the distance over which the bicycle moves.

Furthermore the bicycle further includes a temperature sensor 52 configured to compensate for an error in the detection results of the gyroscope 501 and the acceleration meter 503 due to an influence from temperature.

Furthermore the bicycle further includes a filter 53 configured to correct for the inclination angle as a result of integration to thereby improve the accuracy of the inclination angle.

Optionally the bicycle further includes an alarming whistle 54, and the processor 51 is configured to trigger the alarming whistle 54 to produce an alarm; or the bicycle includes lamps 55, and the processor 51 is configured to trigger a part or all of lamps 55 to be switched on; or the apparatus further includes an RF circuit 56 configured to transmit an alarm signal to a terminal paired with the bicycle, where the alarm signal is configured to notify the terminal paired with the bicycle that the bicycle is stolen; and optionally the alarm signal can be embodied in the form of a short message or a call by phone. Furthermore if the terminal paired with the bicycle is an intelligent key, then the alarm signal can be further configured to control the intelligent key to vibrate or to make a sound.

Optionally the RF circuit 56 is configured to transmit the alarm signal to the terminal paired with the bicycle through a Bluetooth module; or to transmit the alarm signal to the terminal paired with the bicycle through an infrared module; or to transmit the alarm signal to the terminal paired with the bicycle over a wireless network.

Optionally the RF circuit 56 is further configured to transmit the current position information to the terminal paired with the bicycle after an alarm signal is transmitted to the terminal paired with the bicycle.

Furthermore the processor 51 is further configured: to obtain a length of time for which the bicycle has been stationary; and if the length of time reaches a preset length of time threshold, to enable a lock on the bicycle to lock the bicycle, where the preset length of time can be preset freely, for example, the value of the preset length of time can be 30 minutes.

Optionally the RF circuit 56 is configured to receive position information of the terminal paired with the bicycle; and the processor 51 is configured to calculate the distance between the terminal and the bicycle according to position information of the terminal, and the current position information of the bicycle, and if the calculated distance reaches a preset distance threshold, to enable a lock on the bicycle to lock the bicycle, where the preset distance threshold can be preset freely, fore example, the preset distance threshold can be 100 meters.

Furthermore the apparatus further includes a webcam 57 configured, if the obtained current position information is different from the pre-stored initial position information of the bicycle, to obtain an image of the current surrounding environment of the bicycle, and to transmit the obtained image of the current surrounding environment to the terminal paired with the bicycle through the RF circuit 56.

Furthermore the apparatus further includes a microphone 58 configured, if the obtained current position information is different from the pre-stored initial position information of the bicycle, to obtain sound of the current surrounding environment of the bicycle, and to transmit the obtained sound of the current surrounding environment to the terminal paired with the bicycle through the RF circuit 56.

With this technical solution, a human operator can obtain the image or sound of the current surrounding environment of the stolen bicycle using the terminal to thereby further facilitate getting back the bicycle, where the processor 51 is connected with the microphone through an audio circuit 580.

Furthermore the bicycle further includes a power supply 59 configured to power the respective components in the bicycle.

Furthermore the bicycle further includes a memory 60 configured to store the initial position information, and applications.

In summary, in the embodiments of the disclosure, if the bicycle is locked, then the current position information of the bicycle will be obtained; the current position information can be compared with the pre-stored initial position information of the bicycle; and if the current position information is different from the initial position information of the bicycle, then the alarming operation will be performed. With the technical solutions according to the embodiments of the disclosure, if it is determined that the current position information of the bicycle is different from the initial position information of the bicycle, then the alarming operation will be performed so that the user can obtain the state of the bicycle in a timely manner, thus improving in effect the theft-proof function of the bicycle; and it can be determined only by comparing the two pieces of position information whether to perform the alarming operation to thereby safeguard the bicycle conveniently and rapidly.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A bicycle theft-proof method, comprising:
obtaining current position information of a bicycle which is locked;
comparing the current position information with pre-stored initial position information of the bicycle, which is information about the position where the bicycle is located while being locked; and
performing an alarming operation if the current position information is different from the initial position information of the bicycle.

2. The method according to claim 1, wherein before the current position information of the bicycle is obtained, the method further comprises:
detecting, by a gyroscope, a change of angle of the bicycle.

3. The method according to claim 1, wherein obtaining the current position information of the bicycle comprises:
obtaining the current position information of the bicycle through a Global Positioning System (GPS); or
obtaining the current position information of the bicycle using an acceleration meter and a gyroscope according to initial position information of the bicycle.

4. The method according to claim 3, wherein obtaining the current position information of the bicycle using the acceleration meter and the gyroscope according to the initial position information of the bicycle comprises:
determining, by the gyroscope, an angular speed of the moving bicycle;
temporally integrating the angular speed, and determining an angle at which the moving bicycle is inclined;
calculating acceleration of the bicycle according to the inclination angle;
determining a direction in which and a distance over which the bicycle moves, according to the acceleration of the bicycle; and
obtaining the current position information of the bicycle according to the initial position information of the bicycle, and the direction in which and the distance over which the bicycle moves.

5. The method according to claim 1, wherein performing the alarm operation comprises:
triggering art alarm whistle to produce an alarm; or
triggering a part or all of lamps on the bicycle to be switched on; or
transmitting an alarm signal to a terminal paired with the bicycle.

6. The method according to claim 2, wherein performing the alarm operation comprises:
triggering an alarm whistle to produce an alarm; or
triggering a part or all of lamps on the bicycle to be switched on; or
transmitting an alarm signal to a terminal paired with the bicycle.

7. The method according to claim 5, wherein transmitting the alarm signal to the terminal paired with the bicycle comprises:
transmitting the alarm signal to the terminal paired with the bicycle through a Bluetooth module;
transmitting the alarm signal to the terminal paired with the bicycle through an infrared module;
transmitting the alarm signal to the terminal paired with the bicycle over a wireless network.

8. The method according to claim 1, wherein after an alarm signal is transmitted to a terminal paired with the bicycle, the method further comprises:
transmitting the current position information to the terminal paired with the bicycle.

9. The method according to claim 2, wherein after an alarm signal is transmitted to a terminal paired with the bicycle, the method further comprises:
transmitting the current position information to the terminal paired with the bicycle.

10. A bicycle theft-proof apparatus, comprising a position information obtaining device, a memory, and one or more processors, wherein:
one or more programs are stored in the memory, wherein when the one or more programs are executed by the one or more processors:
the position information obtaining device is configured to obtain current position information of the bicycle which is locked;
the one or more processors are configured to compare the current position information with pre-stored initial position information of the bicycle, which is information about the position where the bicycle is located while being locked; and
perform an alarming operation if the current position information is different from the initial position information of the bicycle.

11. The apparatus according to claim 10, wherein the position information obtaining device is further configured:
to detect a change of angle of the bicycle before the current position information of the bicycle is obtained.

12. The apparatus according to claim 10, wherein the position information obtaining device is configured:
to obtain the current position information of the bicycle; or
to obtain the current position information of the bicycle according to the initial position information of the bicycle.

13. The apparatus according to claim 12, wherein the position information obtaining device configured to obtain the current position information of the bicycle according to the initial position information of the bicycle is configured:
to determine an angular speed of the moving bicycle, to temporally integrate the angular speed, and to determine an angle at which the moving bicycle is inclined;
to calculate acceleration of the bicycle according to the inclination angle; and
to instruct the one or more processors to determine a direction in which and a distance over which the bicycle moves, according to the acceleration of the bicycle, and to obtain the current position information of the bicycle according to the initial position information of the bicycle, and the direction in which and the distance over which the bicycle moves.

14. The apparatus according to claim 10, wherein the one or more processors are configured:
to trigger an alarm whistle to produce an alarm; or
to trigger a part or all of lamps on the bicycle to be switched on; or
to instruct a communication unit in the apparatus to transmit an alarm signal to a terminal paired with the bicycle in response to the alarm of the alarming unit.

15. The apparatus according to claim 11, wherein the one or more processors are configured:
to trigger an alarm whistle to produce an alarm; or
to trigger a part or all of lamps on the bicycle to be switched on; or
to instruct a communication unit in the apparatus to transmit an alarm signal to a terminal paired with the bicycle in response to the alarm of the alarming unit.

16. The apparatus according to claim 14, further comprising a transceiver configured:
to transmit the alarm signal to the terminal paired with the bicycle through a Bluetooth module; or
to transmit the alarm signal to the terminal paired with the bicycle through an infrared module; or
to transmit the alarm signal to the terminal paired with the bicycle over a wireless network.

17. The apparatus according to claim 10, wherein the transceiver is further configured:
to transmit the current position information to a terminal paired with the bicycle after an alarm signal is transmitted to the terminal paired with the bicycle.

18. The apparatus according to claim 11, wherein the transceiver is further configured:
to transmit the current position information to a terminal paired with the bicycle after an alarm signal is transmitted to the terminal paired with the bicycle.
